(19) United States
(12) Patent Application Publication
(10) Pub. No.: US 2003/0113015 A1
(43) Pub. Date: Jun. 19, 2003

(54) Method and apparatus for extracting text information from moving image

(76) Inventor: Toshiaki Tanaka, Fukaya-Shi (JP)

Correspondence Address: FOLEY AND LARDNER, SUITE 500, 3000 K STREET NW, WASHINGTON, DC, 20007, US

(21) Appl. No.: 10/020,098

(22) Filed: Dec. 18, 2001

(51) Int. Cl. G06K 9/34

(52) U.S. Cl. 382/176

(57) ABSTRACT

An object such as a book or the like which contains text is photographed as a moving image, a still image is extracted from the moving image and undergoes broad-range identification to identify a text region, and image information in the text region is converted into text information, thus generating document data which can be processed later.

### BACKGROUND OF THE INVENTION

The present invention relates to a method and apparatus for extracting text information contained in a moving image.

A read means of a copying machine or read scanner, which is used normally, reads a document surface by scanning it using a carriage mirror in a direction parallel to the page surface, while the document is fixed in position, so as to accurately reproduce the document. Alternatively, a document sheet is fed one by one by a through-read system, and a document image is reflected by a stationary mirror and is focused via a lens on a linear CCD image sensing element. The CCD image sensing element stores line image information in a memory in turn, and a plurality of pieces of line image information are joined in the memory to reproduce a page image, which is converted into digital data or is printed out.

However, such apparatus can read only a sheet document but cannot read a book document formed by binding many pages.

Japanese Patent Laid-Open No. 9-200451 has proposed an apparatus which can read a book document, and detects a change in page by comparing the image density between pages.

Japanese Patent Laid-Open No. 2000-201358 has proposed a video recording apparatus for joining respective still images that form a moving image into a single panoramic image.

However, there is no technique for efficiently extracting text contained in a book or in a photographed moving image, and generating document data that can be processed later.

### SUMMARY OF THE INVENTION

It is, therefore, an object of the present invention to provide an apparatus and method, which identify a text region from a moving image in consideration of text information with high possibility of future use of image information contained in a book or moving image, convert image information in the text region into text information, and outputs document data with high processability.

According to the present invention, there is provided a method of extracting text information from a moving image, comprising the steps of: generating moving image information by photographing an object to be photographed, which contains text; extracting a still image contained in the moving image information; identifying a text region contained in the still image; and converting image information of the identified text region into text information.

Note that the step of generating the moving image information by photographing the object to be photographed may comprise the steps of: checking if the object to be photographed is set on a document table; making display for prompting an operator to set the object to be photographed when the object to be photographed is not set; and generating the moving image information by photographing the object to be photographed, which is set on the document table.

The step of extracting the still image contained in the moving image information may comprise the steps of: extracting a still image having a moving rate not more than a predetermined value of an image contained in the moving image information; and storing the extracted still image in a memory.

The memory may be a computer-readable recording medium.

The step of identifying the text region contained in the still image may comprise the steps of: checking if text of the text region is recognizable, increasing, if the text is not recognizable and photographing is in progress, a zoom ratio of a photographing device until the text becomes recognizable, and increasing, if the text is not recognizable and photographing has already been done, a zoom ratio of the photographed still image; generating, when text does not become recognizable if a maximum zoom ratio is set, image information obtained by combining the text region and a non-text region contained in the still image, and the step of converting the image information in the identified text region into the text information, may comprise the step of: converting, if the text of the text region is recognizable, the image information in the text region into the text information by executing an OCR process of the text region.

The step of increasing the zoom ratio of the photographing device may comprise the step of: moving the image until a horizontal edge and/or a vertical edge are/is detected after the zoom ratio is increased, checking if the text region is present, and passing, if the text region is present, the control to the step of converting the image region in the identified text region into the text information.

A method of extracting text information from a moving image by utilizing a network according to the present invention, comprises the steps of: on a user side, generating moving image information by photographing an object to be photographed, which contains text; and sending the moving image information to a service provider via a communication network, and on the service provider side, extracting a still image contained in the received moving image information; identifying a text region contained in the still image; converting image information of the identified text region into text information; and sending the converted text information to the user via the communication network or sending a recording medium that stores the text information to the user.

An apparatus for extracting text information from a moving image according to the present invention, comprises a photographing device for generating moving image information by photographing an object to be photographed, which contains text, a still image extraction unit for extracting a still image contained in the moving image information, a text region identification unit for identifying a text region contained in the still image, and a text information conversion unit for converting image information of the identified text region into text information.

Note that the still image extraction unit may comprise an image moving rate discrimination unit for extracting a still image having a moving rate not more than a predetermined value of an image contained in the moving image information, and a memory for storing the extracted still image.

The memory may be a computer-readable recording medium.

An apparatus for extracting text information from a moving image by utilizing a network according to the present invention, comprises, on a user side, a photographing device for generating moving image information by photographing an object to be photographed, which contains text, a sending device for sending the moving image information to a service provider via a communication network, and on the service provider side, a still image extraction unit for extracting a still image contained in the moving image information, a text region identification unit for identifying a text region contained in the still image, a text information conversion unit for converting image information of the identified text region into text information, and a sending device for sending the converted text information to the user via the communication network.

The still image extraction unit may comprise an image moving rate discrimination unit for extracting a still image having a moving rate not more than a predetermined value of an image contained in the moving image information, and a memory for storing the extracted still image.

The memory may be a computer-readable recording medium.

### BRIEF DESCRIPTION OF THE DRAWINGS

FIG. 1 is a block diagram showing the arrangement of an apparatus for extracting text information from a moving image according to an embodiment of the present invention;

FIG. 2 is an explanatory view showing a document which has text information and image information, and from which text information can be extracted using the apparatus shown in FIG. 1;

FIGS. 3A and 3B are flow charts showing the processing procedure in a method of extracting text information from a moving image according to an embodiment of the present invention;

FIG. 4A is a flow chart showing the procedure for executing an image process of a video signal obtained by photographing, and storing the processed signal in a memory;

FIG. 4B is a flow chart showing the procedure of a process for extracting a still image from a moving image;

FIG. 5 is a flow chart showing display of a window used to prompt the operator to set a document;

FIG. 6 is a flow chart showing the procedure for executing a digital zoom process to identify text;

FIG. 7 is a flow chart showing the procedure of a process for combining document data obtained by recognizing text by an OCR process of a text region, and a non-text region;

FIG. 8 is an explanatory view showing network connection between a user and a service provider;

FIG. 9 is a flow chart showing the procedure executed when the user requests the service provider to provide a service via the network; and

FIG. 10 is a flow chart showing the procedure executed when the user registers himself or herself in the service provider.

### DESCRIPTION OF THE PREFERRED EMBODIMENTS

Preferred embodiments of the present invention will be described hereinafter with reference to the accompanying drawings.

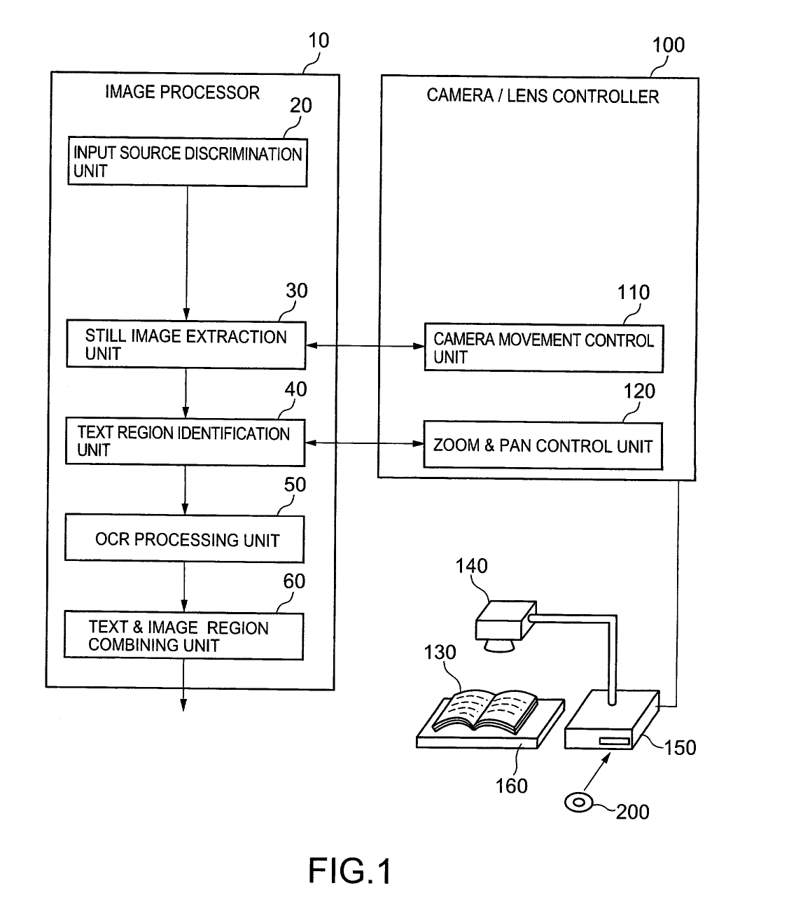

FIG. 1 shows the arrangement of an apparatus for extracting text information from a moving image according to this embodiment. This apparatus comprises an image processor 10 for executing a predetermined process for a moving image signal obtained upon extraction, and a camera/lens controller 100 for controlling the operation of a camera 140, which is included in a document reader 150 for reading a document 130 placed on a document table 160, and of a lens which is included in the camera 140. Note that the camera 140 is not a still camera but a video camera which can photograph a moving image.

The image processor 10 comprises an input source discrimination unit 20, still image extraction unit 30, text region identification unit 40, OCR processing unit 50, and text & image region combining unit 60. The camera/lens controller 100 comprises a camera movement control unit 110 and zoom & pan control unit 120.

The input source discrimination unit 20 discriminates the input source of a moving image signal input to the image processor 10, i.e., if the moving image signal is a photographed moving image signal or a moving image signal to be photographed using the document reader 150.

The still image extraction unit 30 extracts a still image included in the moving image signal. If the input source is a moving image signal to be photographed using the document reader 150, the unit 30 extracts a still image in collaboration with camera movement control by the camera tile control unit 110.

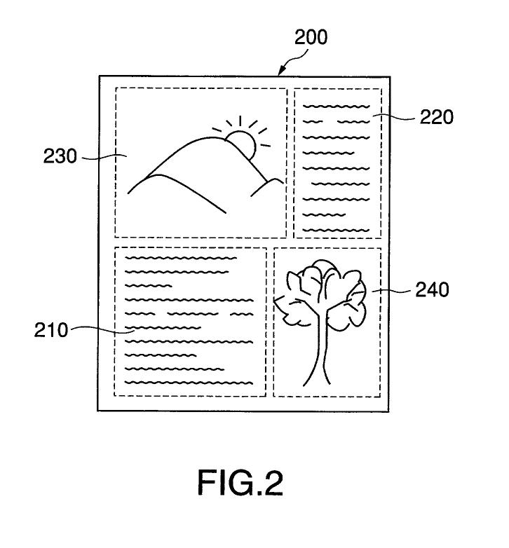

As shown in FIG. 2, an extracted still image 200 normally includes text regions 210 and 220, and image regions (non-text regions) 230 and 240. The text region identification unit 40 identifies the text regions 210 and 220 from the text regions 210 and 220 and image regions 230 and 240 included in the extracted still image 200. If the input source is a moving image signal to be photographed using the document reader 150, the unit 40 identifies the text regions in collaboration with zoom & pan control of the zoom & pan control unit 120.

The OCR processing unit 50 executes an OCR (optical character reader) process for each identified text region to acquire text information from the image information.

The text & image region combining unit 60 outputs data obtained by combining the text and image regions when acquisition of text information has failed (a case wherein acquisition of text information has succeeded may be included). This process is done as a risk management process to prepare for future possibility of use of text information even though acquisition of text information has failed, and is to obtain some output even when the resolution and reproducibility are low.

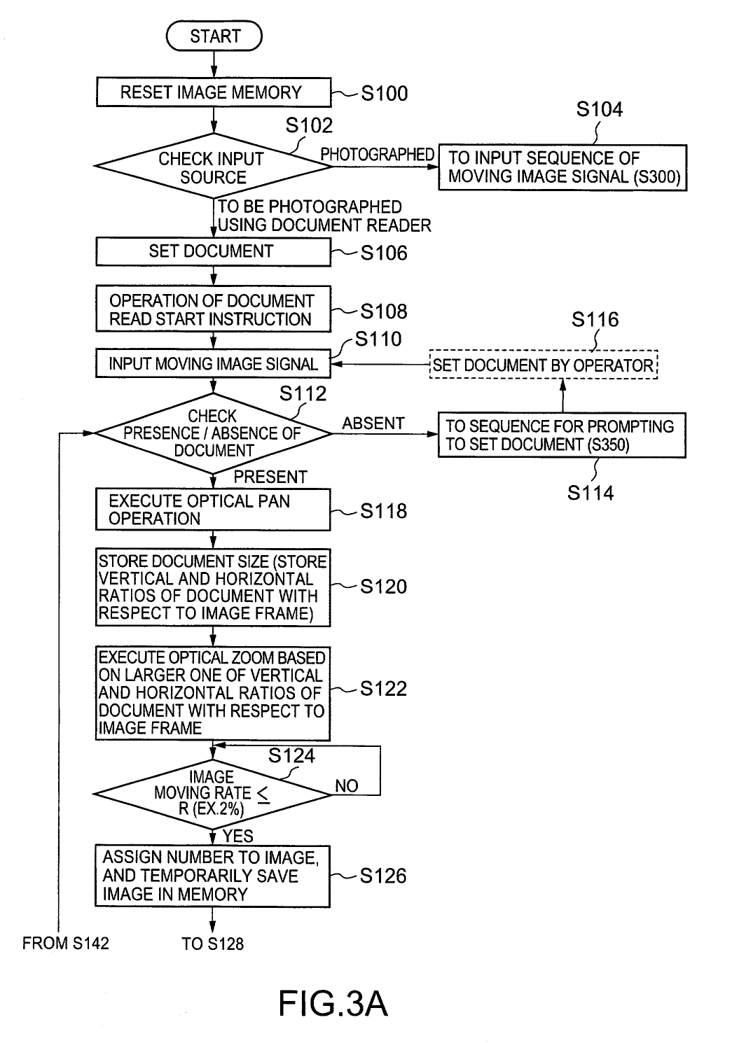

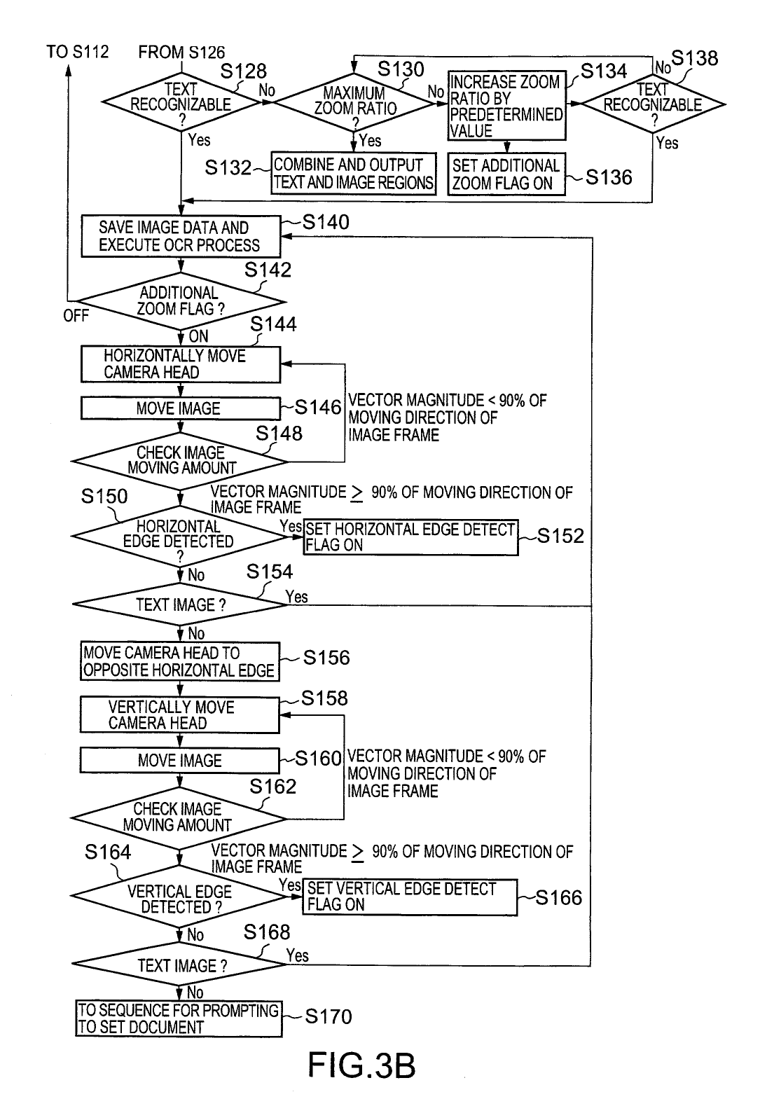

The operation of this embodiment with the above arrangement will be described below using the flow charts in FIGS. 3A and 3B.

In step S100, an image memory is reset.

The input source discrimination unit 20 of the image processor 10 discriminates the input source of a moving image signal input to the image processor 10 in step S102, i.e., checks if that signal is a photographed moving image signal or a moving image signal to be photographed using the document reader 150.

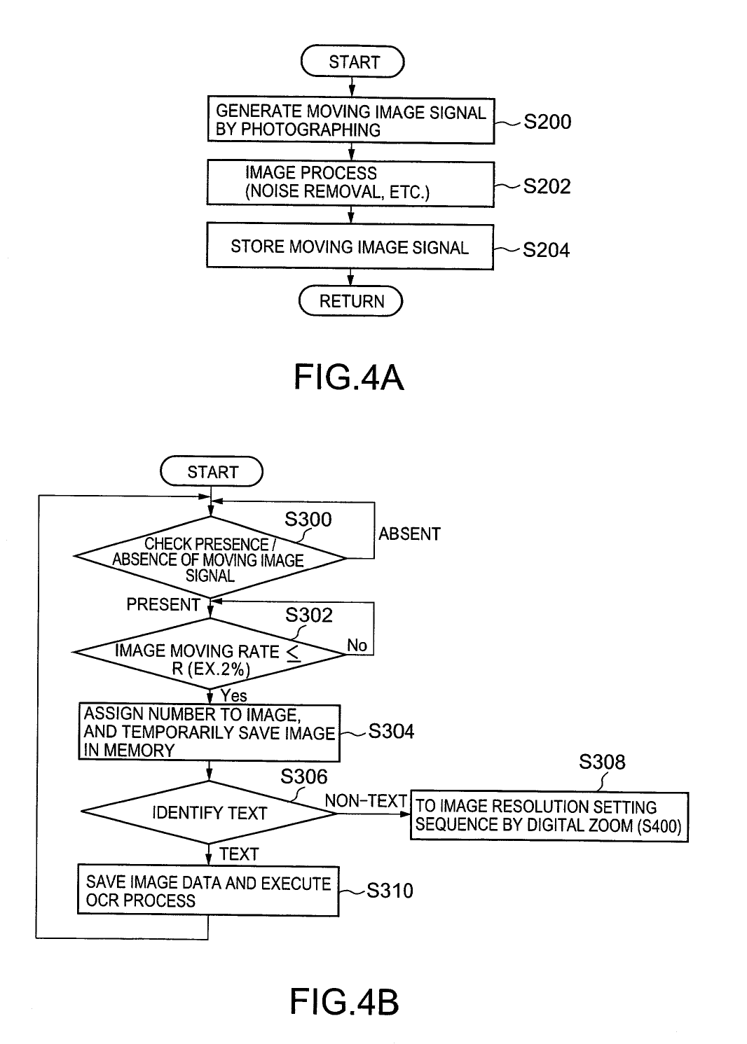

If the input moving image signal is a photographed signal, the flow advances to step S104 to execute a sequence for inputting the moving image signal. Upon starting this sequence, a moving image signal must have been acquired in the procedure shown in FIG. 4A.

In step S200, an object containing text is photographed using a moving image photographing device such as a video camera or the like to generate a moving image signal.

The obtained moving image signal is temporarily stored in a computer-readable recording medium such as a memory, hard disk, tape, or the like.

The moving image signal undergoes a predetermined image process such as noise removal or the like in step S202, and the processed signal is stored in an arbitrary recording medium in step S204.

The obtained moving image signal is input in the procedure shown in FIG. 4B. The presence/absence of a moving image signal is checked in step S300. If no moving image signal is available, the flow returns to step S300.

If the moving image signal is available, the flow advances to step S302 to execute an extraction process of a still image. More specifically, it is checked if the moving ratio of an image is equal to or smaller than a predetermined value R (e.g., 2%). If the moving ratio is larger than the predetermined value R, the flow returns to step S302. If the moving ratio of the image is equal to or smaller than the predetermined value R, it is determined that the image is a still image, and image data of the obtained still image is assigned a number and is saved in the image memory in step S304.

Note that the image memory is a computer-readable recording medium, and may be an externally detachable recording medium such as a CD (Compact Disc)-RW (Rewritable) 200, MO (Magneto Optical) disk, or the like shown in FIG. 1.

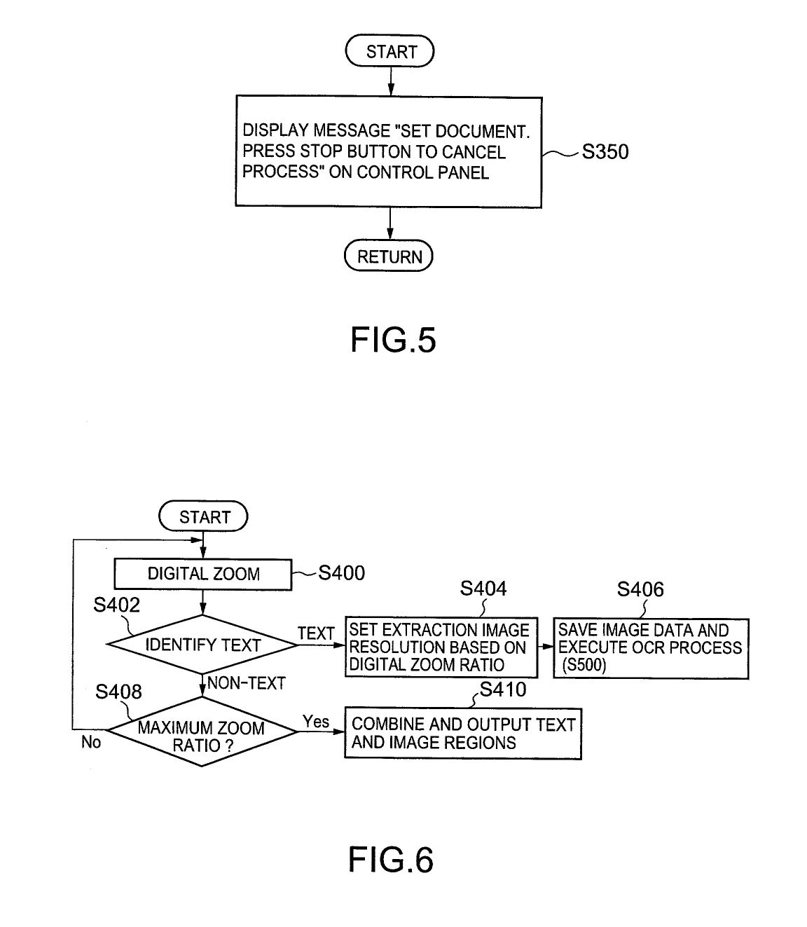

It is checked in step S306 if text contained in the temporarily saved image data is recognizable. If text is not recognizable, the flow advances to step S308 to execute step S400 shown in FIG. 6. If text is recognizable, the image data is saved and undergoes an OCR process by the OCR processing unit 50 in step S310.

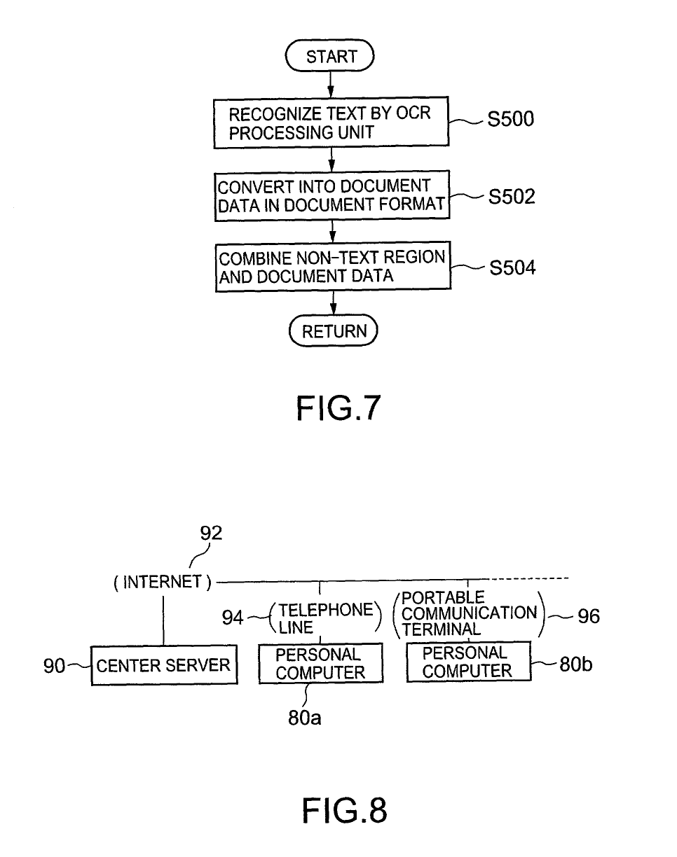

Note that the OCR process is done according to the procedure shown in FIG. 7. In step S500, the OCR processing unit 50 recognizes text contained in the image data.

In step S502, the image data is converted into document data in a document format on the basis of the recognized text.

In step S504, the obtained document data and image data of the image regions (non-text regions) that do not contain any text are combined.

Upon completion of the OCR process in step S310 in FIG. 4B, the flow returns to step S300.

A case will be exemplified below using FIG. 6 wherein it is determined in step S306 that text is not recognizable, and the flow advances to step S308 to execute a digital zoom process.

In step S400, the image data undergoes a digital zoom process.

It is checked in step S402 if text is identifiable. If text is identifiable, the flow advances to step S404. In step S404, the resolution of the image to be extracted is set on the basis of the digital zoom ratio at that time. In step S406, the image data is saved in the image memory, and the aforementioned OCR process is executed.

If it is determined that text is not identifiable, it is checked in step S408 if the zoom ratio is maximum. If the zoom ratio is not maximum, the flow returns to step S400. If the zoom ratio is maximum, it is determined that it is impossible to identify text, and information that combines text and image regions is output in step S410.

If it is determined in step S102 in FIG. 3A that the input source is a moving image signal to be photographed using the document reader 150, a document is set in step S106.

In step S108, the operator inputs a document read start instruction to the document reader 150.

In step S10, a moving image signal photographed by the camera 140 is input.

It is checked in step S112 based on the input moving image signal if the document 130 is present on the document table 160. Upon checking the presence/absence of the document 130, the obtained moving image signal is compared with an image obtained by photographing only the document table 160 using the camera 140. If the two signals match, it is determined that no document 130 is set; if the two signals are different, it is determined that the document 130 is set.

If it is determined that no document 130 is set, the flow advances to step S114 to execute a sequence for prompting to set a document. This sequence displays a message “Set document. Press stop button to cancel process.” on a control panel for the operator in step S350 in FIG. 5.

If it is determined that the document 130 is set, the flow advances to step S118 to execute an optical pan operation. The pan operation of the camera 140 is controlled by the zoom & pan control unit 120.

In step S120, the size of the document 130 is stored in the memory using the captured moving image signal. This size is expressed as the vertical and horizontal ratios of the document with respect to an image frame formed by the moving image signal. Note that the size of the document 130 is recognized by recognizing the document table 160 located as the background of the document 130.

In step S122, an optical zoom operation is made on the basis of the larger ratio of the stored vertical and horizontal ratios of the document with respect to the image frame, i.e., the size that has a smaller margin with respect to the image frame.

In step S124, the still image extraction unit 30 captures a still image contained in the moving image signal. For example, if the moving ratio of the image is equal to or smaller than the predetermined value R (e.g., 2%), a still image is determined and is extracted.

Upon reading the document 130 using the document reader 150, only a still image is automatically extracted from a moving image that stands still for a predetermined period of time every time the operator turns the page of the document 130.

Note that the still image extraction process can use the state-of-the-art technique disclosed in Japanese Patent Laid-Open Nos. 7-23322, 8-9314, and the like. For example, the difference of image information between frames that form a moving image is calculated, and if the difference is equal to or smaller than the predetermined value, a still image is determined. Alternatively, when an image remains unchanged (moved) for a predetermined period of time for each frame, a still image is determined. By setting the predetermined period of time as the reference of decision to be an arbitrary duration, a degree of freedom can be provided to the still image extraction process.

In step S126, the extracted still image is assigned a number, and is temporarily saved as image data in the image memory.

It is checked in step S128 in FIG. 3B if text contained in the temporarily saved image data is recognizable.

If text is recognizable, the flow advances to step S140 to save that image data in the image memory, and the OCR processing unit 50 executes the aforementioned OCR process. If text is not recognizable, the flow advances to step S130.

It is checked in step S130 if the zoom ratio is maximum. If the zoom ratio is maximum, it is determined that no more accurate text information can be extracted. The flow advances to step S132 to output information that combines the text and image regions.

If it is determined in step S130 that the zoom ratio is not maximum, the zoom ratio is increased by a predetermined value. In this case, an additional zoom flag is set ON in step S136. Furthermore, the flow advances to step S138 to check if text becomes recognizable. If text is recognizable, the flow advances to step S140 to save this image data and to execute the OCR process. If it is determined in step S138 that text is not recognizable, the flow returns to the process for checking if the zoom ratio is maximum, and the flow then advances to step S132 or S134.

Upon completion of the OCR process in step S140, the flow advances to step S142 to check if the additional zoom flag is ON or OFF. If the additional zoom flag is OFF, the flow returns to step S112 in FIG. 3A to repeat the aforementioned process. If the additional zoom flag is ON, the movement operation of the head of the camera 140 is executed in step S144 and subsequent steps.

In step S144, the horizontal movement process of a camera head is started. With this process, the image moves horizontally in step S146. In step S148, the image moving amount is checked. If the vector magnitude that indicates the image moving amount is smaller than 90% of the horizontal direction in which the image frame is moved, the flow returns to step S144 to repeat the camera head movement operation. If the vector magnitude is equal to or larger than 90% of the movement of the image frame in the horizontal direction, the flow advances to step S150.

It is then checked if a horizontal edge is detected. If the horizontal edge is detected, a horizontal edge detect flag is set ON in step S152.

On the other hand, if one horizontal edge is not detected, the flow advances to step S154 to check the presence/absence of a text image. If it is determined that the text image is present, the flow returns to step S140 to save that image data in the image memory and to execute the OCR process.

If it is determined that no text image is present, the flow advances to step S156 to move the camera head to the other horizontal edge.

In step S158, the vertical movement process of the camera head is started. In step S160, the image moves vertically. Instep S162, the image moving amount is checked. If the vector magnitude that indicates the image moving amount is smaller than 90% of the movement of the image frame in the vertical direction, the flow returns to step S158 to repeat the vertical movement operation of the camera head. If the vector magnitude is equal to or larger than 90% of the movement of the image frame in the vertical direction, the flow advances to step S164.

It is then checked if a vertical edge is detected. If the vertical edge is detected, a vertical edge detect flag is set ON in step S166.

On the other hand, if one vertical edge is not detected, the flow advances to step S168 to check the presence/absence of a text image. If it is determined that the text image is present, the flow returns to step S140 to save that image data in the image memory, and to execute the OCR process.

If it is determined that no text image is present, the flow advances to step S170 to execute the sequence for prompting the operator to set a document in step S350 in FIG. 5.

In the conventional system that reads a document image by scanning a document using a scanner, and obtains text information via the OCR process, the scanner requires long time to scan, resulting in inefficient processes.

According to the embodiment described above, a still image is identified based on moving image data photographed by a simple photographing unit having no scanning function or a video photographing device such as a normal video camera or the like as the input source, and text information is extracted from the obtained still image. The extracted text information can be saved and processed as document data.

Therefore, a document can be read at high speed by a moving image photographing process without using any scanner that requires long scan time and has poor efficiency, and text information contained in the read moving image signal is extracted and converted into document data, which can be re-used or can be printed clearly.

When document data is generated from a bound book, that book is set on the document reader, its pages are turned by the operator or a known automatic page turner, and each turned page is photographed while leaving the book open at that page for a predetermined period of time. With this technique, photographing can be done by only turning pages of even a thick book document, and still images can be successively captured at high speed without pressing the document against the document table with the turned pages facing down, and pressing a start button for each copy. In this way, conversion of a book into digital data, that has required much time so far, can be promoted, thus achieving space and capacity savings.

Even when a document consists of not only text information, only a text region except for an image region can be identified, and can undergo character conversion using an OCR process, thus obtaining text information.

Therefore, according to the present invention, the need for an existing still image generation device such as a scanner or the like can be obviated, and text information can be extracted using an arbitrary moving image generation device such as a versatile video camera, which has few limitations.

Note that the images may be combined using a technique for compositing still images to obtain a panoramic image, as disclosed in, e.g., Japanese Patent Laid-Open Nos. 11-134352, 11-69288, and the like.

When the aforementioned zoom function is used, since one frame is segmented into a plurality of blocks, the next frame to be captured is present. Upon capturing segmented frames, if text present on one frame is to be captured continuously, the following two methods may be used.

(1) Before the captured images undergo an OCR process, they are combined into a single image with reference to their overlap portions (e.g., right edges, lower edges).

(2) After the respective frames have undergone an OCR process, document data of overlap portions are checked, and lines are coupled while erasing repetitive data on the overlap portions.

When a text region contained in the extracted still image undergoes an OCR process to generate text information, the format of this text information may be text code format which includes a font format and information that pertains to the character size.

When frames are combined by compositing text information and non-text regions (graphic regions) on the basis of position information of respective regions stored upon broad-range identification, the format of image data may use, e.g., jpeg, tiff, or the like.

An arrangement used when a user and a service provider are connected via a network such as the Internet or the like will be described below.

Upon extracting text information from a text region contained in a still image, an OCR process is required. However, this process normally requires a high-precision OCR processing/arithmetic unit, and it is difficult to implement such process for a simple portable device.

Hence, as shown in FIG. 8, a network is built by connecting users, personal computers 80a, 80b, . . . and a center server 90 of a service provider via an Internet 92 using a telephone line 94, portable communication terminal 96, or the like.

The user sends a moving image photographed using a portable video camera or the like to the center server 90 of the service provider using his or her personal computer 80a (80b, . . . ) via the Internet 92. The service provider executes an OCR process of the received image information using the center server 90 to generate text information, and sends back the information to the personal computer 80a (80b, . . . ) via the Internet 92. Such service system can be built.

With this system, since the user can obtain text information contained in a moving image without purchasing any expensive OCR processing device, a cost reduction can be achieved.

(a) Operation Procedure Upon Receiving Service

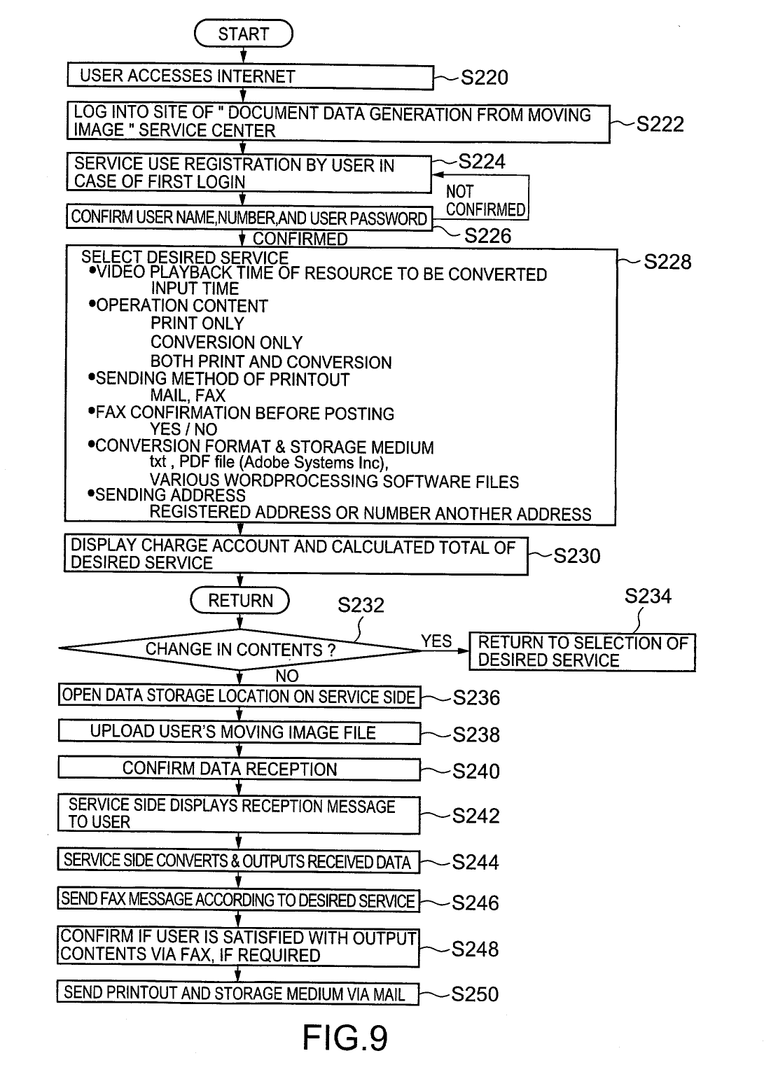

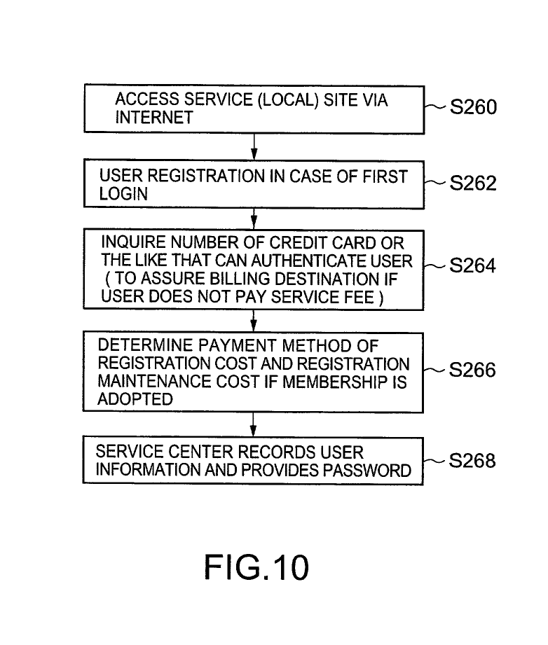

A case will be explained below using FIG. 9 wherein the user generates a moving image file of a moving image signal, which is photographed by a video camera, using a personal computer, and downloads that file to the Internet.

The user accesses the Internet in step S220 and logs into the site of the service center that provides a service for generating document data from a moving image signal in step S222.

If the user receives that service for the first time, he or she makes service use registration in step S224.

In step S226, the user inputs his or her user name, ID number, and user password, which are confirmed by the center server of the service provider.

Upon completion of confirmation, the flow advances to step S228 to execute the following process.

The user selects a desired service (generation of document data).

The user inputs a video playback time of the resource to be converted.

The user selects as the operation contents one of print only, conversion into text information only, and both print and conversion.

If the user wants to obtain a printout, he or she selects one of mail and FAX as the sending method of that printout.

If the user selects mail, he or she also selects if a send message is required in advance via FAX before posting.

The user selects as the document data format one of text data, a PDF file (Adobe Systems Inc.), and various wordprocessing software files. Also, the user selects the type of storage medium used to save document data.

The user designates one of the registered address or another address as a destination address.

In step S230, the charge accounts and total amount of the desired service are displayed.

It is confirmed in step S232 if the user wants to change the contents.

If the user wants to change the contents, the flow returns to selection of a desired service (step S230) via step S234. If the user does not want to change the contents, the flow advances to step S236.

In step S236, the service provider opens the data storage location of the center server to the user.

In step S238, the user uploads the moving image file onto the Internet.

In step S240, the service provider confirms reception of the data.

In step S242, the service provider displays a data reception message for the user.

In step S244, the service provider converts the received moving image file into document data, and outputs it.

In step S246, the service provider sends the printout via the FAX in accordance with the user's desired service contents, i.e., if he or she wants to receive the printout via FAX.

In step S248, the user sends to the service provider a FAX message indicating if he or she is satisfied with the output contents, so as to confirm the contents.

In step S250, the printout and saved medium are sent via mail according to the user's desired service contents.

(b) Process Associated with Service Use Registration by User

In step S260, the user accesses the service (local) site of the service provider via the Internet.

In step S262, the user makes user registration if that access is the first access.

In step S264, the number and the like of a credit card which can be used to authenticate the user is inquired. This is to assure the billing destination if the user does not pay a service fee.

In step S266, a payment method of registration cost and registration maintenance cost is determined if these costs are required.

In step S268, information associated with the user is recorded, and a password is sent to the user.

As the charge method for the user, a service fee may be demanded via a settlement organization such as a credit account designated upon user registration or the Internet service provider, or a bill may be directly sent to the user.

According to the aforementioned service provided via the Internet, the following effects are obtained. An OCR processing device requires a high-precision OCR processing/arithmetic unit, and it is difficult to make such device both inexpensive and portable. If the user uses such device very rarely, the load of purchasing such expensive device is too heavy for such user.

Hence, the user does not purchase such OCR processing device, but requests a service provider having an OCR processing device of a conversion process from image information to text information. That is, the user photographs a moving image, generates image data that can be transferred, and sends that data to the service provider via the Internet. The service provider provides a service for executing an OCR process of the received image information, and sending back extracted text information to the user as a digital data file. In this way, a plurality of users can share expensive hardware, i.e., the OCR processing device, thus improving the operating efficiency of the device, and reducing the user's cost.

The above embodiments are merely examples, and do not limit the present invention. Various modifications may be made within the technical scope of the present invention.

For example, in the above embodiment, the user and service provider are connected via the Internet. However, the present invention is not limited to the Internet, and they may be connected via other communication networks.

In the service for extracting text information from a moving image, and sending document data to the user via the Internet, document data may be directly sent to a station which is designated by the user and can execute a print process, so as to output a printout.

What is claimed is:

1. A method of extracting text information from a moving image, comprising the steps of:
generating moving image information by photographing an object to be photographed, which contains text;
extracting a still image contained in the moving image information;
identifying a text region contained in the still image; and
converting image information of the identified text region into text information.

2. A method according to claim 1, wherein the step of generating the moving image information by photographing the object to be photographed comprises the steps of:
checking if the object to be photographed is set on a document table;
making display for prompting an operator to set the object to be photographed when the object to be photographed is not set; and
generating the moving image information by photographing the object to be photographed, which is set on the document table.

3. A method according to claim 1, wherein the step of extracting the still image contained in the moving image information comprises the steps of:
extracting a still image having a moving rate not more than a predetermined value of an image contained in the moving image information; and
storing the extracted still image in a memory.

4. A method according to claim 3, wherein the memory is a computer-readable recording medium.

5. A method according to claim 1, wherein the step of identifying the text region contained in the still image, comprises the steps of:
checking if text of the text region is recognizable, increasing, if the text is not recognizable and photographing is in progress, a zoom ratio of a photographing device until the text becomes recognizable, and increasing, if the text is not recognizable and photographing has already been done, a zoom ratio of the photographed still image;
generating, when text does not become recognizable if a maximum zoom ratio is set, image information obtained by combining the text region and a non-text region contained in the still image, and the step of converting the image information in the identified text region into the text information, comprises the step of:
converting, if the text of the text region is recognizable, the image information in the text region into the text information by executing an OCR process of the text region.

6. A method according to claim 5, wherein the step of increasing the zoom ratio of the photographing device, comprises the step of:
moving the image until a horizontal edge and/or a vertical edge are/is detected after the zoom ratio is increased, checking if the text region is present, and passing, if the text region is present, the control to the step of converting the image region in the identified text region into the text information.

7. A method of extracting text information from a moving image, comprising the steps of:
on a user side,
generating moving image information by photographing an object to be photographed, which contains text; and
sending the moving image information to a service provider via a communication network, and
on the service provider side,
extracting a still image contained in the received moving image information;
identifying a text region contained in the still image;
converting image information of the identified text region into text information; and
sending the converted text information to the user via the communication network or sending a recording medium that stores the text information to the user.

8. A method according to claim 7, wherein the step of generating the moving image information by photographing the object to be photographed, comprises the steps of:
checking if the object to be photographed is set on a document table;
making display for prompting an operator to set the object to be photographed when the object to be photographed is not set; and
generating the moving image information by photographing the object to be photographed, which is set on the document table.

9. A method according to claim 7, wherein the step of extracting the still image contained in the moving image information, comprises the steps of:
extracting a still image having a moving rate not more than a predetermined value of an image contained in the moving image information; and
storing the extracted still image in a memory.

10. A method according to claim 9, wherein the memory is a computer-readable recording medium.

11. A method according to claim 7, wherein the step of identifying the text region contained in the still image, comprises the steps of:
checking if text of the text region is recognizable, increasing, if the text is not recognizable and photographing is in progress, a zoom ratio of a photographing device until the text becomes recognizable, and increasing, if the text is not recognizable and photographing has already been done, a zoom ratio of the photographed still image;
generating, when text does not become recognizable if a maximum zoom ratio is set, image information obtained by combining the text region and a non-text region contained in the still image, and
the step of converting the image information in the identified text region into the text information, comprises the step of:
converting, if the text of the text region is recognizable, the image information in the text region into the text information by executing an OCR process of the text region.

12. A method according to claim 11, wherein the step of increasing the zoom ratio of the photographing device, comprises the step of:
moving the image until a horizontal edge and/or a vertical edge are/is detected after the zoom ratio is increased, checking if the text region is present, and passing, if the text region is present, the control to the step of converting the image region in the identified text region into the text information.

13. An apparatus for extracting text information from a moving image, comprising:
a photographing device for generating moving image information by photographing an object to be photographed, which contains text;
a still image extraction unit for extracting a still image contained in the moving image information;
a text region identification unit for identifying a text region contained in the still image; and
a text information conversion unit for converting image information of the identified text region into text information.

14. An apparatus according to claim 13, wherein said still image extraction unit comprises:
an image moving rate discrimination unit for extracting a still image having a moving rate not more than a predetermined value of an image contained in the moving image information; and
a memory for storing the extracted still image.

15. An apparatus according to claim 14, wherein said memory is a computer-readable recording medium.

16. An apparatus for extracting text information from a moving image, comprising:
on a user side,
a photographing device for generating moving image information by photographing an object to be photographed, which contains text;
a sending device for sending the moving image information to a service provider via a communication network, and
on the service provider side,
a still image extraction unit for extracting a still image contained in the moving image information;
a text region identification unit for identifying a text region contained in the still image;
a text information conversion unit for converting image information of the identified text region into text information; and
a sending device for sending the converted text information to the user via the communication network.

17. An apparatus according to claim 16, wherein said still image extraction unit comprises:
an image moving rate discrimination unit for extracting a still image having a moving rate not more than a predetermined value of an image contained in the moving image information; and
a memory for storing the extracted still image.

18. An apparatus according to claim 17, wherein said memory is a computer-readable recording medium.
